(19) United States
(12) Patent Application Publication
(10) Pub. No.: US 2024/0310995 A1
(43) Pub. Date: Sep. 19, 2024

(54) INFORMATION PROCESSING APPARATUS AND WINDOW MOVEMENT CONTROL METHOD

(71) Applicant: Lenovo (Singapore) Pte. Ltd., Singapore (SG)

(72) Inventors: Ryohta Nomura, Kanagawa (JP); Yoshitsugu Suzuki, Kanagawa (JP)

(73) Assignee: Lenovo (Singapore) Pte. Ltd., Singapore (SG)

(21) Appl. No.: 18/426,676

(22) Filed: Jan. 30, 2024

(30) Foreign Application Priority Data
Mar. 16, 2023 (JP) 2023-042165

(51) Int. Cl. G06F 3/0488; G06F 3/041; G06F 3/14

(52) U.S. Cl. CPC G06F 3/0488; G06F 3/0412; G06F 3/1423

(57) ABSTRACT

An information processing apparatus for controlling display on a plurality of displays includes: a registration unit that registers, for each of the displays, display information indicating whether the display is a touch panel display; and a display control unit that, in response to detection of a predetermined gesture on the touch panel display, moves a foreground window between the touch panel display on which the gesture was detected and another one of the displays.

### CROSS-REFERENCE TO RELATED APPLICATIONS

This application claims priority to Japanese Patent Application No. 2023-042165 filed on Mar. 16, 2023, the contents of which are hereby incorporated herein by reference in their entirety.

### TECHNICAL FIELD

The present disclosure relates to an information processing apparatus and a window movement control method.

### BACKGROUND

Conventionally, an information processing apparatus including, as a display, a touch panel display that enables pen input with a touch pen (pen-type input device) is known (see, for example, Japanese Unexamined Patent Application Publication No. 2022-090171). In recent years, there have been increasing opportunities to connect a plurality of displays to work in a multi-display environment.

For example, it is conceivable to connect an information processing apparatus including a touch panel display as an external device to efficiently perform content editing work by utilizing both an input operation using a keyboard, a mouse, and the like and an input operation using a touch pen. Since a keyboard enables efficient text input and a pen enables efficient handwriting input, combining them is expected to improve work efficiency.

In the case of working by properly using different input devices such as a touch pen, a keyboard, and the like, it is necessary to switch the display for displaying a window to be edited, depending on the input device used. For example, in the case of typing using a keyboard, a screen facing the user, or in other words, a screen in an upright position is more convenient for operation. On the other hand, a screen close to a horizontal position is more convenient for pen input.

Therefore, an application window to be edited (hereinafter, referred to as “foreground window”) may be moved between a plurality of displays depending on the input tool used. However, in a multi-display environment, moving a foreground window from one display to another display requires an operation of placing the mouse cursor on the title bar of the foreground window to be moved and dragging the window to the desired display while holding down the mouse button. Furthermore, since a drag-and-drop operation across displays cannot be performed with a touch pen, the operation of moving the foreground window between a plurality of displays requires switching from the pen to the mouse, thus becoming even more complicated.

### SUMMARY

One or more embodiments of the present invention provide an information processing apparatus and a window movement control method capable of realizing movement of a foreground window between displays with an easy input operation.

One or more embodiments of the present disclosure is an information processing apparatus capable of controlling display on a plurality of displays, the apparatus including: a registration unit that registers, for each of the displays, display information indicating whether the display is a touch panel display; and a display control unit that, in response to detection of a predetermined gesture on the touch panel display, moves a foreground window between the touch panel display on which the gesture was detected and another one of the displays.

One or more embodiments of the present disclosure is a window movement control method of moving a foreground window between a plurality of displays, the method including the steps, performed by a computer, of: registering, for each of the displays, display information indicating whether the display is a touch panel display; and in response to detection of a predetermined gesture on the touch panel display, moving the foreground window between the touch panel display on which the gesture was detected and another one of the displays.

One or more embodiments of the present disclosure is a program for causing a computer to function as the information processing apparatus according to the first aspect of the present disclosure.

In the above-described aspects of the present disclosure, “on the touch panel display” does not require whether or not there is a contact with the touch panel display. In other words, “on the touch panel display” means that the gesture only needs to be performed within the range detectable by the touch sensor; the gesture may be performed in contact with the touch panel display, or the gesture may be performed in the vicinity where it can be detected by the touch sensor, without contact with the touch panel display.

The above-described aspects of the present disclosure have the effect of realizing the movement of a foreground window between displays with an easy input operation.

### BRIEF DESCRIPTION OF THE DRAWINGS

FIG. 1 is a schematic external view of an information processing system according to one or more embodiments of the present disclosure;

FIG. 2 is a schematic configuration diagram illustrating an example of the hardware configuration of an information processing apparatus according to one or more embodiments of the present disclosure;

FIG. 3 is a functional configuration diagram illustrating an example of a window movement control function possessed by the information processing apparatus according to one or more embodiments of the present disclosure;

FIG. 4 is a flowchart illustrating an example of the processing procedure of a window movement control method performed by the information processing apparatus according to one or more embodiments of the present disclosure; and

FIG. 5 is a schematic external view of an information processing system according to a variation of the present disclosure.

### DETAILED DESCRIPTION

An information processing apparatus and a window movement control method according to one or more embodiments of the present disclosure will be described below with reference to the drawings. In one or more embodiments, a desktop PC will be given as an example of the information processing apparatus 10, although it is not limited thereto. The information processing apparatus 10 may be, for example, a laptop PC, a tablet terminal, or the like.

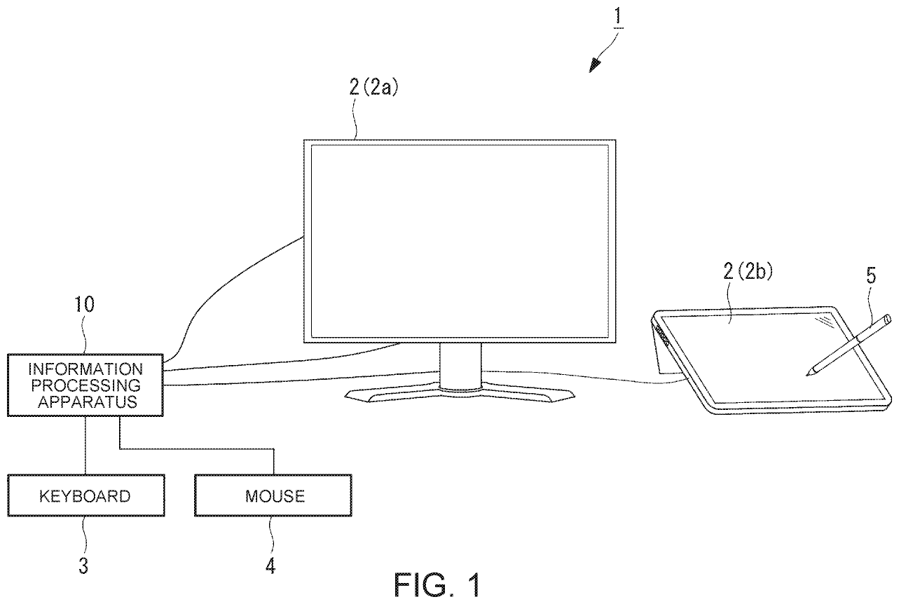

FIG. 1 is a schematic external view of an information processing system 1 according to one or more embodiments of the present disclosure. As illustrated in FIG. 1, the information processing system 1 includes an information processing apparatus 10 and a plurality of displays 2 (2a, 2b). The information processing apparatus 10 includes a multi-display function capable of controlling the display on the plurality of displays 2. While the case where two displays 2 are connected to the information processing apparatus 10 is illustrated in FIG. 1, the number of displays connected is not limited thereto. In the following, in the case where it is necessary to distinguish between the displays 2, they will be referred to as a first display 2a and a second display 2b, while in the case where it is not necessary to distinguish between them, the displays will simply be referred to as the displays 2. Furthermore, although the case where the information processing apparatus 10 and the two displays 2 are connected in a wired manner is illustrated in FIG. 1, the connection manner is not particularly limited. These devices may be connected in a wired manner or in a wireless manner.

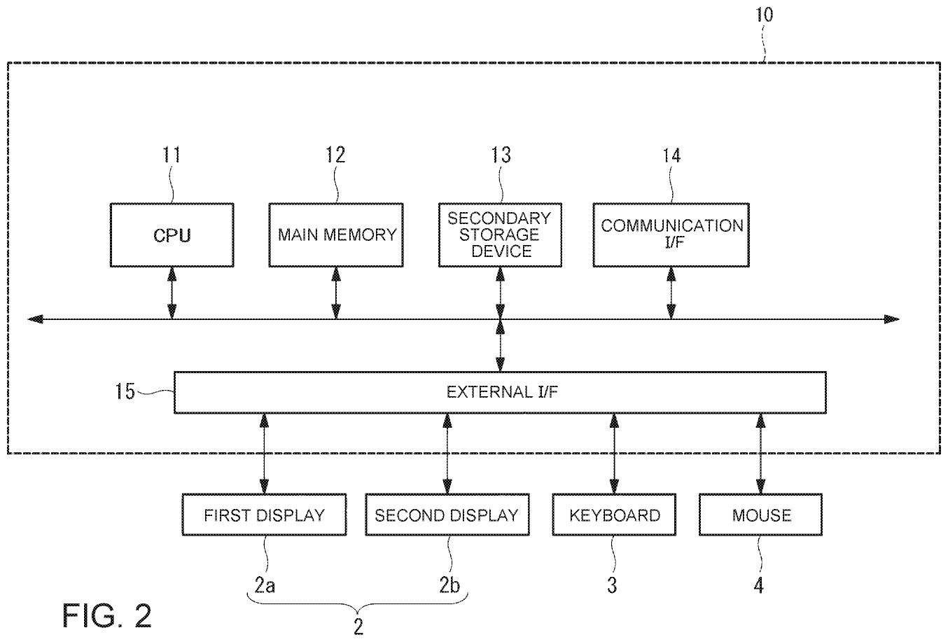

FIG. 2 is a schematic configuration diagram illustrating an example of the hardware configuration of the information processing apparatus 10 according to one or more embodiments. As illustrated in FIG. 2, the information processing apparatus 10 includes a CPU (processor) 11, a main memory 12, a secondary storage device 13, a communication interface 14, and an external interface 15. These units are connected to each other directly or indirectly via a bus, to perform various processing in cooperation with each other.

The CPU 11 performs overall control of the information processing apparatus 10 by an operating system (OS) stored in the secondary storage device 13 connected via a bus, for example, and also executes various programs stored in the secondary storage device 13 to perform various processing. A plurality of such CPUs 11 may be provided to cooperate with each other to realize the processing.

The main memory 12 is configured with a writable memory such as, for example, a cache memory, a random access memory (RAM), or the like, and is utilized as a work area for reading programs executed by the CPU 11, writing data processed by the executed programs, and the like.

The secondary storage device 13 is a non-transitory computer readable storage medium. Examples of the secondary storage device 13 include a read only memory (ROM), a hard disk drive (HDD), and a flash memory. The secondary storage device 13 stores an OS for overall control of the information processing apparatus 10 such as, for example, Windows (registered trademark), iOS (registered trademark), Android (registered trademark), or the like, Basic Input/Output System (BIOS), various device drivers for hardware operation of peripheral devices, various application software, and various data and files. The secondary storage device 13 also stores programs for realizing various processing, and various data necessary for realizing the various processing. Two or more secondary storage devices 13 may be provided, and the data as described above may be divided and stored in the secondary storage devices 13.

The communication interface 14 functions as an interface that connects to a network to communicate with other apparatuses for transmitting and receiving information. For example, the communication interface 14 communicates with other apparatuses in a wired or wireless manner. Examples of the wireless communication include communications via lines such as Bluetooth (registered trademark), Wi-Fi, 3G, 4G, 5G, LTE, and a wireless local area network (LAN). Examples of the wired communication include communications via lines such as a wired LAN.

The external interface 15 is an interface for connection with external devices. The first display 2a, the second display 2b, the keyboard 3, and the mouse 4 are connected to the CPU 11 via the external interface 15. The external interface 15 includes, for example, input/output terminals and interfaces suitable for respective devices connected.

The first display 2a is composed of, for example, a liquid crystal display (LCD), an organic electroluminescence (EL) display, or the like.

The second display 2b is a touch panel display having a touch panel with a plurality of touch sensors superimposed on, for example, an LCD, an organic EL display, or the like, and enables direct input operations using an indicator such as a touch pen (pen-type input device: indicator) 5, a finger, or the like. For the touch sensor, one of capacitive type, pressure sensitive type, or the like can be adopted. For the pen, one of capacitive type, pressure sensitive type, electromagnetic induction type, or the like can be adopted.

The keyboard 3 and the mouse 4, examples of the input devices, are user interfaces for a user to issue an instruction to the information processing apparatus 10.

Input information that a user inputs by operating the touch pen 5 is also input to the information processing apparatus 10 via the second display 2b.

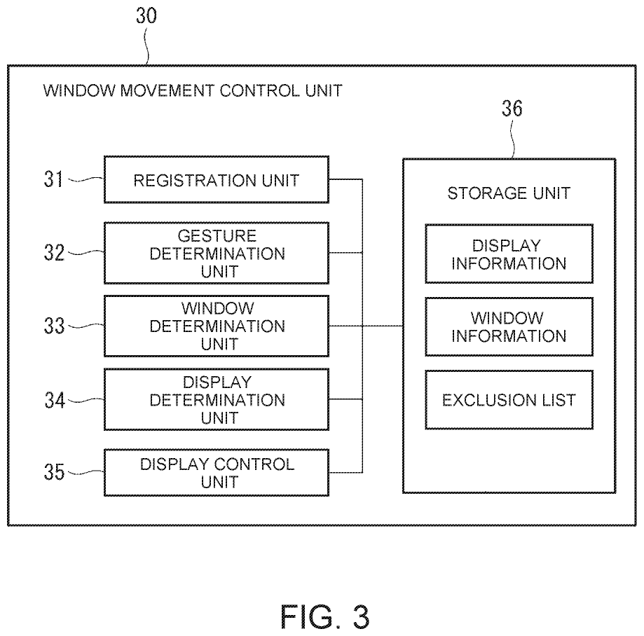

FIG. 3 is a functional configuration diagram illustrating an example of a window movement control function possessed by the information processing apparatus 10 according to one or more embodiments. By way of example, a series of processes for realizing the functions described below is stored in the secondary storage device 13 in the form of a program (e.g., a window movement control program), and the CPU 11 reads this program to the main memory 12 and performs information processing and arithmetic computations to realize the functions. The program is applicable in the form preinstalled in the secondary storage device 13, in the form stored in another computer readable storage medium, in the form delivered via a wired or wireless communication device, or the like. Examples of the computer readable storage medium include a magnetic disk, a magneto-optical disk, a CD-ROM, a DVD-ROM, and a semiconductor memory.

As illustrated in FIG. 3, the information processing apparatus 10 includes a window movement control unit 30. The window movement control unit 30 includes, by way of example, a registration unit 31, a gesture determination unit 32, a window determination unit 33, a display determination unit 34, a display control unit 35, and a storage unit 36.

The registration unit 31 registers, for each display 2 under display control of the information processing apparatus 10, for example, display information indicating whether the display is a touch panel display. For example, the registration unit 31 determines whether the display is a touch panel display based on display identification information for identifying the display, generates display information based on the determination result, and stores the information in the storage unit 36.

The display identification information is, for example, an identification number that is uniquely assigned to each display product. Examples of the display identification information include a display device name and a display ID. The display ID is a number unique to the display product, and different numbers are assigned according to, for example, suppliers, display panel structures, or the like. The display ID makes it possible to readily determine whether the display is a touch panel display.

While one or more embodiments is configured such that the registration unit 31 determines whether the display is a touch panel display based on the display identification information, the configuration is not limited thereto. For example, it may be configured such that a user manually sets whether the display is a touch panel display from a predetermined setting screen.

The display information includes display placement information. The display placement information, which is information necessary for realizing a multi-display environment, can be acquired from, for example, the OS. For example, the registration unit 31 acquires placement information of the displays from the OS, and registers the acquired display placement information in the storage unit 36 in the form to be included in the display information.

Accordingly, the display information, including the display placement information (in one or more embodiments, information that the first display 2a is placed on the left side and the second display 2b is placed on the right side) and the information indicating whether each display 2 is a touch panel display, is stored in the storage unit 36.

The gesture determination unit 32 determines whether a predetermined gesture has been detected on the touch panel display. In the case where a user performs a predetermined gesture using a pen, finger, or other indicator on the second display 2b, the gesture is detected by the touch panel and is notified to the information processing apparatus 10 as input information. The gesture determination unit 32 determines whether the predetermined gesture has been detected on the second display 2b based on the input information from the second display 2b. Examples of the predetermined gesture include an action of moving the pen from front to back in the vicinity on the touch panel, an action of moving the pen in the left or right direction, an action of drawing a predetermined symbol or letter, and an action of tapping or swiping the touch panel with one or more fingers. Thus, the predetermined gesture may be any gesture registered in advance, which can be selected arbitrarily. It may also be configured to be configurable by a user.

The window determination unit 33 is operable, in response to detection of a predetermined gesture on the second display 2b, to determine whether the foreground window is a movable window. For example, the storage unit 36 stores an exclusion list in which information on windows that cannot be moved between displays is registered. In the case where a predetermined gesture is detected on the second display 2b, the window determination unit 33 determines whether the foreground window is registered in the exclusion list, and if not, determines that it is a movable window. In the exclusion list, for example, desktop, pop-up, context menu, and the like are registered.

The display determination unit 34 is operable, in response to detection of a predetermined gesture on the second display 2b, to determine whether the foreground window is being displayed in full screen on the second display 2b. Here, the full-screen display does not require whether a title bar and the like are displayed or not. In other words, whether the full-screen display has the title bar displayed or not can be selected as appropriate according to the operation.

In the case where a predetermined gesture is detected on the second display 2b, the display control unit 35 moves the foreground window between the first display 2a and the second display 2b. Specifically, if the display determination unit 34 determines that the foreground window is not being displayed in full screen, the display control unit 35 displays the foreground window on the second display 2b. At this time, the display control unit 35 displays the foreground window in full screen. This provides an environment in which a user can easily input with a pen, leading to improved work efficiency.

In the case of moving the foreground window from the first display 2a to the second display 2b, the display control unit 35 may acquire the display position and display size of the foreground window on the first display 2a and store them as window information in the storage unit 36.

If the display determination unit 34 determines that the foreground window is being displayed in full screen, the display control unit 35 moves the foreground window to the first display 2a. At this time, the display control unit 35 may display the foreground window on the first display 2a based on the window information stored in the storage unit 36. With this, when the foreground window is moved from the second display 2b back to the first display 2a, the window can be displayed in the same position and the same size as the last time (before the movement).

It should be noted that if the window determination unit 33 determines that the foreground window is a non-movable window, the display control unit 35 does not move the foreground window.

The storage unit 36 stores various data necessary for realizing the window movement control function described above. For example, the storage unit 36 stores the display information registered by the registration unit 31, the exclusion list used by the window determination unit 33, the window information on the first display 2a stored by the display control unit 35, and the like.

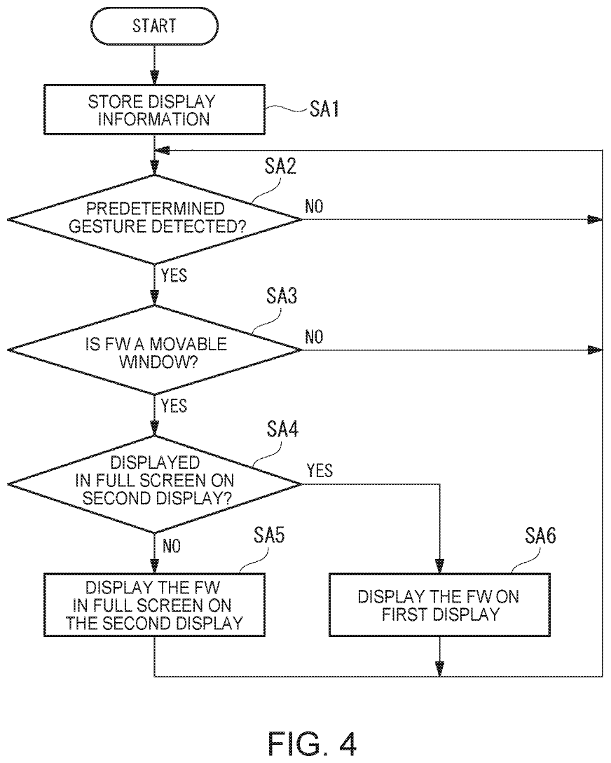

A window movement control method performed by the information processing apparatus 10 according to one or more embodiments will now be described with reference to FIG. 4. FIG. 4 is a flowchart illustrating an example of the processing procedure of the window movement control method performed by the information processing apparatus 10 according to one or more embodiments. The following series of processes are performed by the CPU 11 that reads the program stored in the secondary storage device 13 to the main memory 12 and performs the information processing and arithmetic computations.

The following processes are performed during the use in a multi-display environment.

First, display information on the displays 2 connected is stored in the storage unit 36 (SA1). Specifically, display placement information is acquired from the OS, and also a determination is made whether each display 2 is a touch panel display based on the display ID of each display 2. Display information is generated based on the determination result and the display placement information, and stored in the storage unit 36. In this manner, the display placement information indicating that the first display 2a is placed on the left side and the second display 2b is placed on the right side, and the information indicating that the first display 2a is a non-touch panel display and the second display 2b is a touch panel display are stored as the display information in the storage unit 36.

Subsequently, it is determined whether a predetermined gesture has been detected on the second display 2b (SA2). If it is determined that a predetermined gesture has not been detected (NO in SA2), the process is repeated until the predetermined gesture is detected. If the predetermined gesture has been detected (YES in SA2), it is determined whether the foreground window is a movable window (SA3). If it is determined that it is not a movable window (NO in SA3), the process returns to step SA2.

If the foreground window is a movable window (YES in SA3), it is determined whether the foreground window is being displayed in full screen on the second display 2b (SA4). If it is not being displayed in full screen (NO in SA4), the foreground window is displayed in full screen on the second display 2b (SA5), and the process returns to step SA2. With this, for example in the case where the foreground window is being displayed on the first display 2a, the foreground window is moved from the first display 2a to the second display 2b and displayed in full screen. At this time, the display position and display size of the foreground window on the first display 2a may be acquired and stored as window information in the storage unit 36.

It should be noted that if the foreground window is being displayed on the second display 2b in a manner other than full screen, the foreground window is not moved between the displays and the foreground window being displayed on the second display 2b is enlarged and displayed in full screen.

On the other hand, if it is determined in step SA4 that the foreground window is being displayed in full screen (YES in SA4), the foreground window is moved from the second display 2b to the first display 2a for display (SA6), and the process returns to step SA2. At this time, the foreground window may be displayed on the first display 2a based on the window information stored in the storage unit 36.

As described above, according to one or more embodiments, the information processing apparatus 10 includes the registration unit 31 which registers, for each display 2, display information indicating whether the display is a touch panel display, and the display control unit 35 which, in response to detection of a predetermined gesture on the second display (touch panel display) 2b, moves the foreground window between the first display (the other display) 2a and the second display (the touch panel display on which the gesture was detected) 2b.

According to such a configuration, the user can move the foreground window between the first display and the second display by performing a predetermined gesture on the second display 2b, which is a touch panel display. This enables a foreground window movement operation using the touch pen 5, eliminating the need for the user to switch between the touch pen 5 and the mouse 4 as in the conventional case. As a result, the movement of the foreground window between displays can be realized with an easy input operation.

Furthermore, according to one or more embodiments, when the foreground window is moved to the second display, the foreground window is displayed in full screen. This eliminates the need for the user to enlarge the foreground window, and provides an environment in which the user can easily perform the input operation.

According to one or more embodiments, when the foreground window is moved from the first display 2a to the second display 2b, the display position and display size of the foreground window on the first display 2a are registered, and when the foreground window is to be moved from the second display 2b to the first display 2a, the foreground window is displayed based on the display position and display size registered. This allows the user to continue the content editing work without a feel of discomfort.

Furthermore, according to one or more embodiments, the window determination unit is provided which determines whether the foreground window is a movable window, and the display control unit 35 moves the foreground window only when it is determined to be a movable window. This can avoid unnecessary movement of the window.

While the embodiment of the present disclosure has been described above, the technical scope of the present disclosure is not limited to the scope described in the above embodiments. Various modifications or improvements to the above embodiments are possible within the range not departing from the gist of the present disclosure, and such modified or improved embodiments are also included within the technical scope of the present disclosure.

In addition, the processing procedure described in the above embodiments is merely an example, and an unnecessary step may be omitted, a new step may be added, or the order of steps may be changed within the range not departing from the gist of the present disclosure.

For example, in the above embodiments, the second display 2b may be a display mounted on an information processing apparatus. In this case, the information processing apparatus having the second display 2b may include the function of the gesture determination unit. In other words, in this case, the information processing apparatus having the second display 2b may determine whether a predetermined gesture has been performed, and may notify the information processing apparatus 10 of the determination result.

Further, while a desktop PC has been given as an example of the information processing apparatus 10 in the above embodiments, the invention is not limited thereto. For example, the information processing apparatus 10 may be a laptop PC, a tablet terminal, or the like, and the information processing apparatus 10 may include the first display 2a. For example, the information processing apparatus 10 may be an information processing apparatus including a touch panel display, and the second display 2b may be a non-touch panel type external monitor. As such, the first display and the second display may be combined in any manner, and three or more displays may be used as a multi-monitor setup.

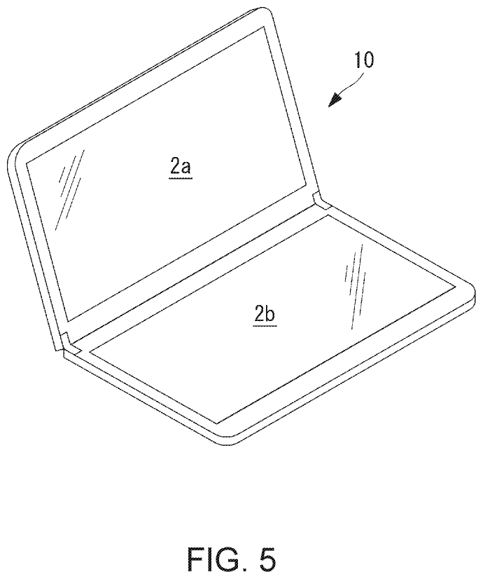

Further, as illustrated in FIG. 5, for example, both of the first display 2a and the second display 2b may be touch panel displays, and both may be included in the information processing apparatus 10. In this case, an input device such as a keyboard 3 or the like suitable for text input may be connected to the information processing apparatus 10 as an external device. The user may perform an input operation using a touch pen 5 when the foreground window is being displayed on the second display 2b, and may perform an input operation using a keyboard 3 and/or a mouse 4 when the foreground window is being displayed on the first display 2a. Further, in this case, the keyboard 3 may be a software keyboard displayed on the second display 2b. In this case, showing/hiding the software keyboard can be controlled in synchronization with the movement of the foreground window between the first display 2a and the second display 2b.

While the gesture for moving the foreground window from the first display 2a to the second display 2b and the gesture for moving the foreground window from the second display 2b to the first display 2a have been the same gesture in the above-described embodiments, the invention is not limited thereto. For example, a calling gesture for moving the foreground window to the second display and a sending gesture for moving the foreground window to the first display may be registered, and the display control unit 35 may move the foreground window according to the detected gesture.

### DESCRIPTION OF SYMBOLS

1 information processing system
2 display
2a first display
2b second display
3 keyboard
4 mouse
5 touch pen
10 information processing apparatus
11 CPU
12 main memory
13 secondary storage device
14 communication interface
15 external interface
30 window movement control unit
31 registration unit
32 gesture determination unit
33 window determination unit
34 display determination unit
35 display control unit
36 storage unit

What is claimed is:

1. An information processing apparatus for controlling display on a plurality of displays, comprising:
a registration unit that registers, for each of the displays, display information indicating whether the display is a touch panel display; and
a display control unit that, in response to detection of a predetermined gesture on the touch panel display, moves a foreground window between the touch panel display on which the gesture was detected and another one of the displays.

2. The information processing apparatus according to claim 1, further comprising a display determination unit that determines whether the foreground window is being displayed in full screen on the touch panel display where the gesture was detected, wherein
the display control unit is operable, in response to determination that the foreground window is not being displayed in full screen on the touch panel display, to display the foreground window in full screen on the touch panel display.

3. The information processing apparatus according to claim 2, wherein the display control unit is operable, in response to determination that the foreground window is being displayed in full screen on the touch panel display, to move the foreground window to the other display.

4. The information processing apparatus according to claim 3, wherein the display control unit is operable
in the case of moving the foreground window from the other display to the touch panel display, to register a display position and display size of the foreground window on the other display, and
in the case of moving the foreground window from the touch panel display to the other display, to display the foreground window based on the display position and display size registered.

5. The information processing apparatus according to claim 1, further comprising a window determination unit operable, in response to detection of the gesture on the touch panel display, to determine whether the foreground window is a movable window, wherein
the display control unit is operable, in response to determination that the foreground window is the movable window, to move the foreground window.

6. The information processing apparatus according to claim 1, wherein the registration unit determines whether a display is a touch panel display based on display identification information for identifying the display, and registers the display information based on the determination result.

7. A window movement control method of moving a foreground window between a plurality of displays, the method comprising the steps, performed by a computer, of:
registering, for each of the displays, display information indicating whether the display is a touch panel display; and
in response to detection of a predetermined gesture on the touch panel display, moving the foreground window between the touch panel display on which the gesture was detected and another one of the displays.

8. A program for causing a computer to function as the information processing apparatus according to claim 1.
